(19) United States
(12) Patent Application Publication
(10) Pub. No.: US 2011/0157870 A1
(43) Pub. Date: Jun. 30, 2011

(54) FLAT LIGHT GUIDE PLATE AND BACKLIGHT MODULE USING THE SAME

(75) Inventors: Huang-Chun LIU, Chungli (TW); Sheng-Ju Chung, Chungli (TW)

(73) Assignee: Global Lighting Technologies, Inc.

(21) Appl. No.: 12/980,423

(22) Filed: Dec. 29, 2010

(30) Foreign Application Priority Data
Dec. 30, 2009 (TW) 098145920

(51) Int. Cl. G02F 1/13357; G02B 6/10

(52) U.S. Cl. 362/97.1; 385/129

(57) ABSTRACT

A backlight module includes a light guide plate and a lighting source. The light guide plate has a main body with a light incidence surface and a light emitting surface. A plurality of accommodating grooves are provided on the light incidence surface, and a plurality of light-separation grooves which are perpendicular to the accommodating grooves are provided on the light emitting surface. The light source includes a circuit board and a plurality rows of light bars welded on the circuit board, where each light bar is composed of a plurality of light emitting diode. When the light source is assembled to the main body, the circuit board is attached to the light incidence surface such that the light bars are disposed for the corresponding accommodating grooves. Therefore, the light-separation grooves can effectively optically separate the light when the light bars are illuminated.

### BACKGROUND OF THE INVENTION

1. Field of the Invention

The present invention relates to a backlight module, and in particular to a backlight module with light-separation effect.

2. Description of Prior Art

A general LCD TV with LED backlight module is still remaining high cost, but the LED backlight module is considered to be a main development for the backlight source of the LCD TV after it is used for the backlight source of the notebook computers. In more particularly, the direct type of LED backlight with local dimming technology has advantages of lower power consumptions, increased display contract ratio, higher gray scale numbers and reduced dynamic image blur, among other types of light sources and will be difficult to replace by other types of light sources.

The local dimming technology of the LCD is one of region control technologies, which achieves backlight supplying for the LCD in different regions and different luminance levels. In order to achieve light-separation, a general backlight module includes a plurality of small size light guide plates and tiles the light guide plates together to from a large light emitting plane.

However, the backlight light module with tiled light guide plate not only effectively achieves light-separation but also produces bright lines (luminescent lines) which are difficult to eliminate between the joint of the adjacent light guide plates.

### SUMMARY OF THE INVENTION

In order to solve the above-mentioned problem, a large size light guide plate is disclosed. The light guide plate includes a plurality of light-separation grooves, so as to eliminate the bright lines and achieve local dimming for separating light.

Accordingly, the present invention provides a backlight module. The backlight module includes a light guide plate and a light source. The light guide plate has a main body with a light incidence surface and a light emitting surface. A plurality of accommodating grooves are provided lengthwise-continuously on the light incidence surface, and plurality of light-separation grooves which are perpendicular to the accommodating are provided lengthwise-continuously on the light emitting surface. The accommodating grooves and the light-separation grooves collectively define a plurality of locally and small light guide surface at the main body. In addition, the main body further includes a light guide part.

The light source includes a circuit board and a plurality of light bars welded on the circuit board, where each light bar is composed of a plurality of light emitting diodes. When the light source is assembled to the main body, the circuit board is attached to the light-incidence surface such that the light bars are disposed for the accommodating and one side of the light guide part.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of a backlight module according to a first embodiment of the present invention;

FIG. 2 is an assemble view of the backlight module;

FIG. 3 is a cross-section view of the backlight module;

FIG. 4 is a top view of the backlight module;

FIG. 5 is a top view of a light guide plate according to a second embodiment;

FIG. 6 is a top view of a light guide plate according to a third embodiment;

FIG. 7 is a top view of a light guide plate according to a fourth embodiment.

### DETAILED DESCRIPTION OF THE INVENTION

A preferred embodiment of the present invention will be described with reference to the drawings.

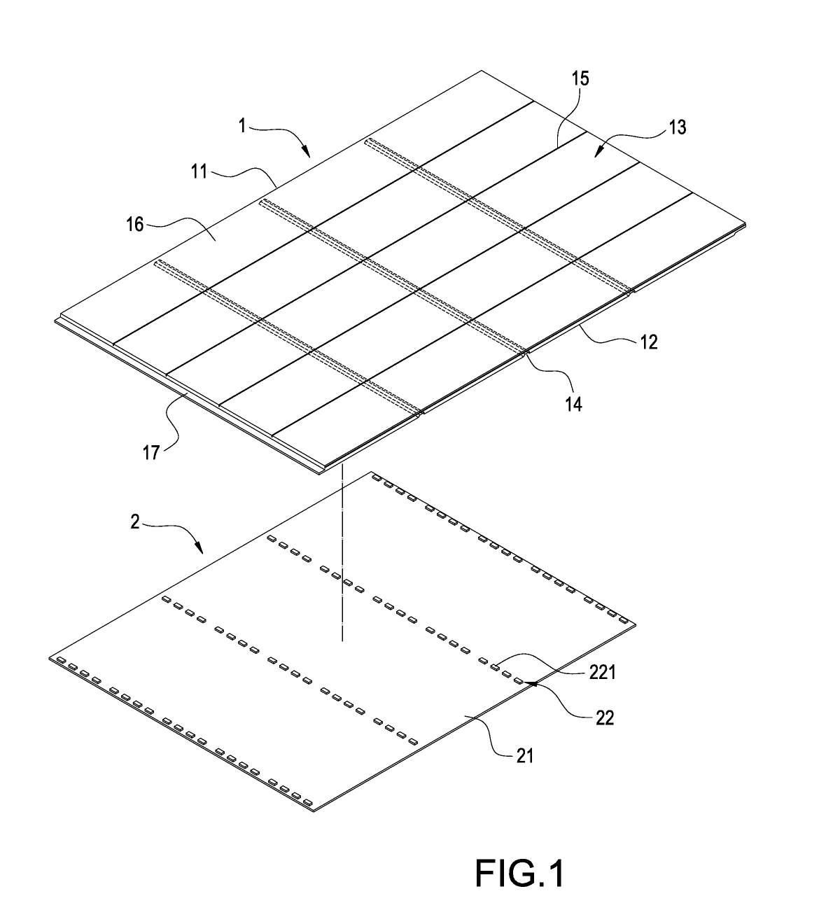

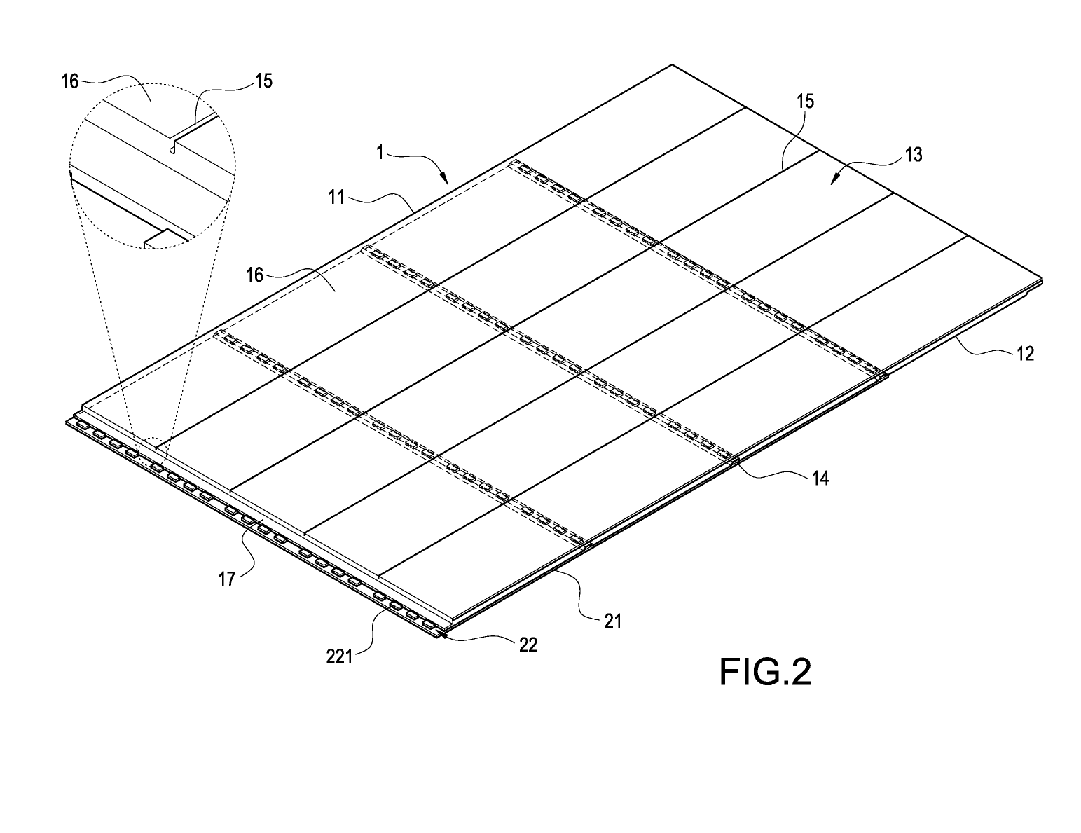

Referring to FIG. 1 and FIG. 2, which are an exploded perspective view and an assemble view of a backlight module according to a first embodiment of the present invention, respectively. The backlight module includes a light guide plate 1 and a light source 2.

The light guide plate 1 has a main body 11. The main body 11 has a light incidence surface 12 and a light emitting surface 13. A plurality of accommodating grooves 14 are provided lengthwise-continuously (namely, continuous in length direction) on the light incidence surface 12. Each accommodating groove 14 has one of U shape or trapezoid shape cross-section. A plurality of light-separation grooves 15 which are perpendicular to the accommodating grooves 14 are provided lengthwise-continuously on the light emitting surface 13. The accommodating grooves 14 and the light-separation grooves 15 collectively define a plurality of local and small light guide surface 16 at the main body 11. Each light-separation groove 15 has one of V shape and U shape cross-section. In addition, one side or two sides of the main body 11 has one light guide part 17 or two light guide parts 17, respectively, for guiding external light.

The light source 2 includes a circuit board 21 and a plurality rows of light bars 22. Each light bar 22 is welded on the circuit board 21 and composed of a plurality of light emitting diodes (LEDs) 220. When the light source 2 is assembled to the main body 11 of the light guide plate 1, the circuit board 21 of the light source 2 is disposed on the light incidence surface 12 of the main body 11 such that the light bars 22 disposed for the corresponding accommodating grooves 14 and one side of the light guide part 17.

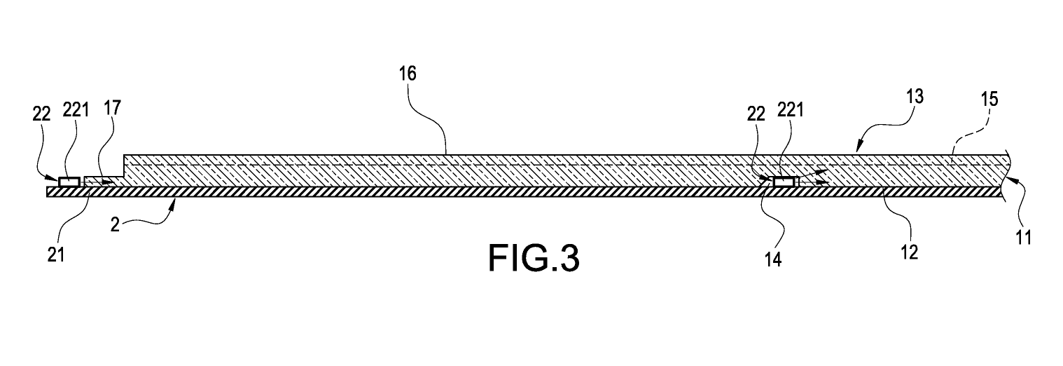

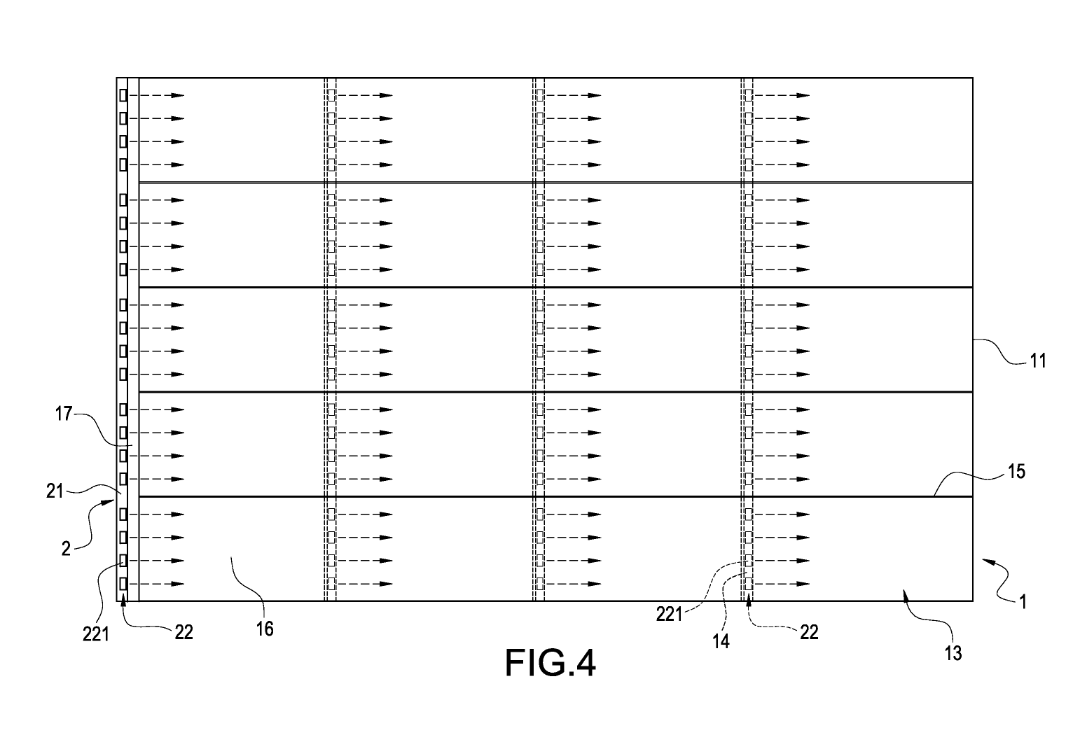

Referring to FIG. 3 and FIG. 4, which are a cross-section view and a top view of a backlight module according to the first embodiment of the present invention, respectively. When the main body 11 of the light guide plate 1 and the light source 2 are assembled, the light bars 22 of the light source 2 can be clearly observed to dispose for the accommodating grooves 14. When the LED 221 of each light bar 22 are illuminated, injects the light into the main body 11 for irradiating thereof. At this time, the light-separation grooves 15 prevent the light injected into the main body 11 from entering another light guide surface 16 adjacent to this light guide surface 16 to effectively separate light diffusing at the light guide surface 16.

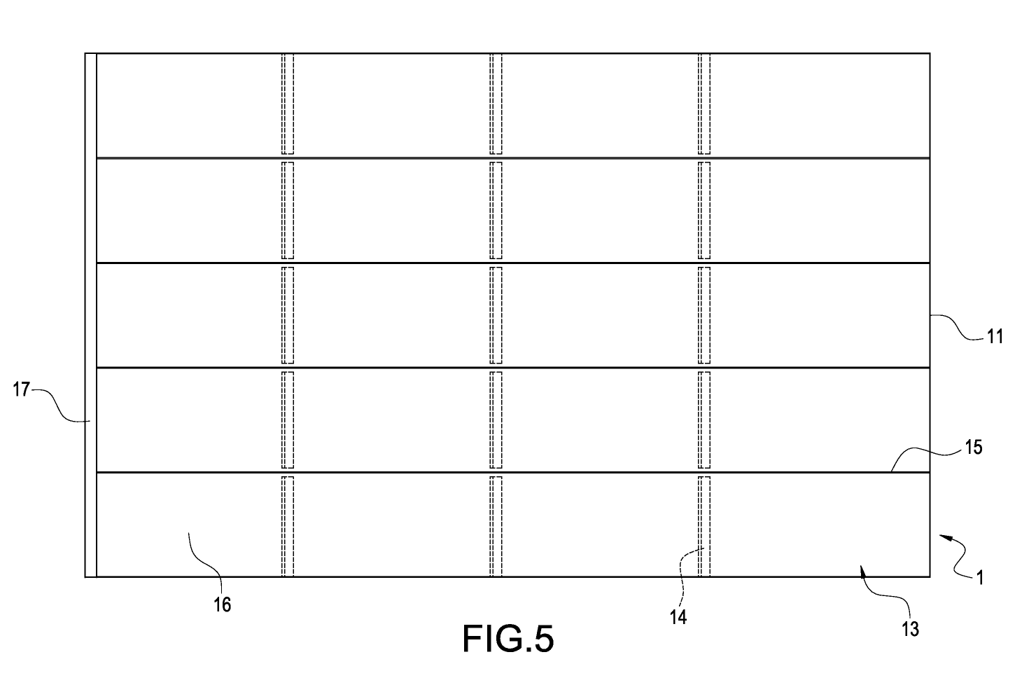

Referring to FIG. 5 is a top view of a light guide plate according to a second embodiment. A plurality of light-separation grooves 15 are provided lengthwise-continuously on the light emitting surface 13, and a plurality of accommodating grooves 14 are provided lengthwise-discontinuously (namely, discontinuous in length direction) in the light incidence surface 12.

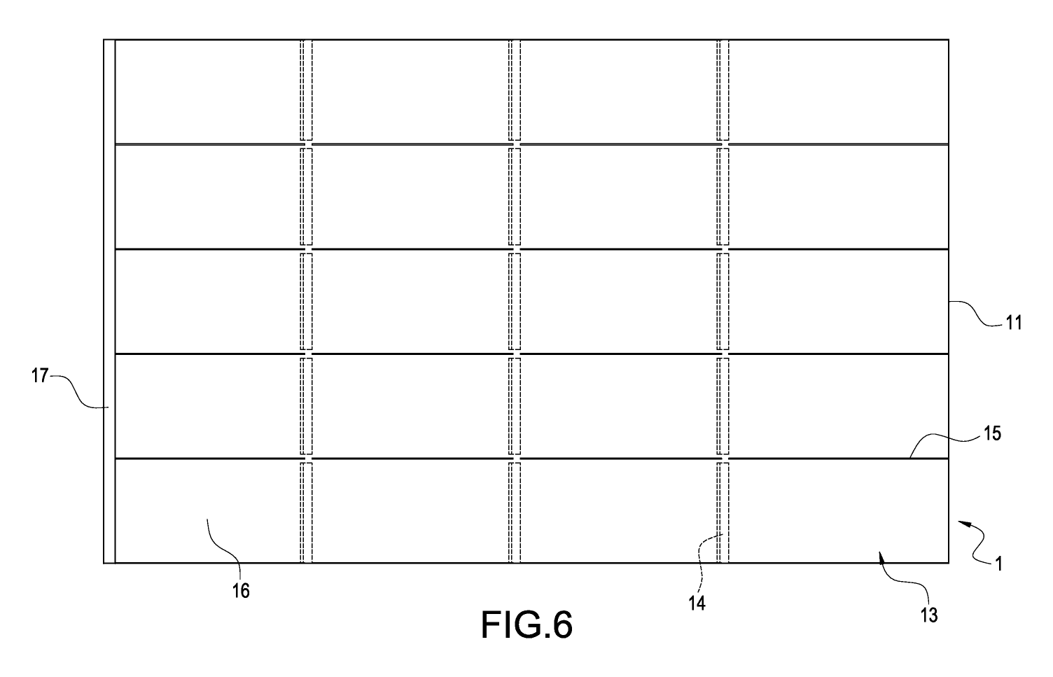

Referring to FIG. 6 is a top view of a light guide plate according to a third embodiment. A plurality of light-separation grooves 15 are provided lengthwise-discontinuously on the light emitting surface 13, and a plurality of accommodating grooves 14 are provided lengthwise-discontinuously in the light incidence surface 12.

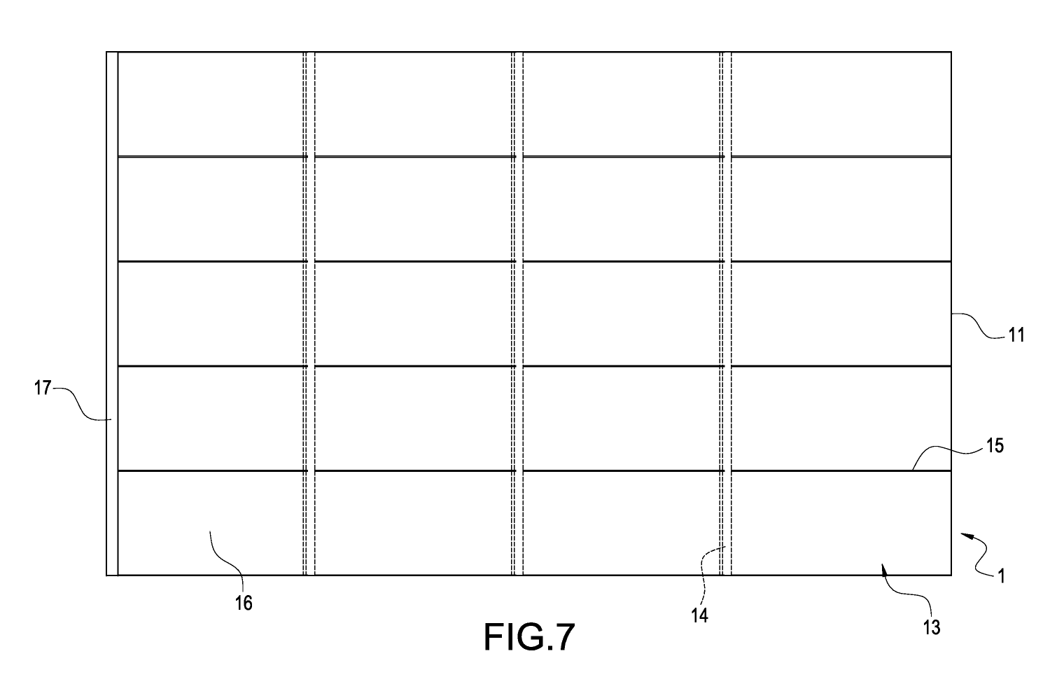

Referred is made to FIG. 7, which is a top view of a light guide plate according to a fourth embodiment. A plurality of light-separation grooves 15 are provided lengthwise-discontinuously on the light emitting surface 13, and a plurality of accommodating grooves 14 are provided lengthwise-continuously in the light incidence surface 12.

As in above description, when the light guide plate with a plurality of light-separation grooves (V shape cross-section) is employed in the local dimming technology, the darkness light guide block corresponding to the light guide surface said above can effectively separates the light injected from adjacent irradiation light guide block. In addition, different light-separation results can be achieved by combining different forms of grooves.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light guide plate comprising a main body with a light incidence surface and a light emitting surface, the light incidence surface having a plurality of accommodating grooves, and the light emitting surface having a plurality of light-separation grooves which are perpendicular to the accommodating grooves, for optically separating the main body into a plurality of local and small light guide surface.

2. The light guide plate in claim 1, wherein each accommodating groove has U shape or trapezoid shape cross-section.

3. The light guide plate in claim 1, wherein each light-separation groove has V shape or U shape cross-section.

4. The light guide plate in claim 1, wherein the light-separation grooves are continuous in length direction and the accommodating grooves are continuous in length direction.

5. The light guide plate in claim 1, wherein the light-separation grooves are continuous in length direction and the accommodating grooves are discontinuous in length direction.

6. The light guide plate in claim 1, wherein the light-separation grooves are discontinuous in length direction and the accommodating grooves are continuous in length direction.

7. The light guide plate in claim 1, wherein the light-separation grooves are discontinuous in length direction and the accommodating grooves are discontinuous in length direction.

8. The light guide plate in claim 1, wherein one side or two sides of the main body has a light guide part or two light guide parts respectively.

9. A backlight module, comprising:
a light guide plate having a main body with a light incidence surface and a light emitting surface, the light incidence surface having a plurality of accommodating grooves, and the light emitting surface having a plurality of light-separation grooves which are perpendicular to the accommodating grooves;
a light source including a circuit board and a plurality of light bars welded on the circuit board, which are disposed on the light incidence surface of the main body and the light bars disposed for the accommodating grooves.

10. The backlight module in claim 9, wherein each accommodating groove has U shape or trapezoid shape cross-section.

11. The backlight module in claim 9, wherein each light-separation groove has V shape or U shape cross-section.

12. The backlight module in claim 9, wherein the light-separation grooves are continuous in length direction and the accommodating grooves are continuous in length direction.

13. The backlight module in claim 9, wherein the light-separation grooves are continuous in length direction and the accommodating are discontinuous in length direction.

14. The backlight module in claim 9, wherein the light-separation grooves are discontinuous in length direction and the accommodating are continuous in length direction.

15. The backlight module in claim 9, wherein the light-separation grooves are discontinuous in length direction and the accommodating grooves are discontinuous in length direction.

16. The backlight module in claim 9, wherein one side or two sides of the main body has a light guide part or two light guide part respectively.

17. The backlight module in claim 16, wherein each light bar is composed of a plurality of light emitting diodes.
